(19) United States
(12) Patent Application Publication
(10) Pub. No.: US 2025/0369191 A1
(43) Pub. Date: Dec. 4, 2025

(54) HEAT SEALABLE BARRIER MATERIAL

(71) Applicant: UPM-Kymmene Corporation, Helsinki (FI)

(72) Inventors: Kuisma LITTUNEN, Helsinki (FI); Leena KUNNAS, Helsinki (FI); Timo TOIVANEN, Helsinki (FI); Esa SAUKKONEN, Helsinki (FI)

(21) Appl. No.: 18/872,757

(22) PCT Filed: Jun. 10, 2022
(86) PCT No.: PCT/FI2022/050404

§ 371 Date: Dec. 6, 2024

(51) Int. Cl. D21H 19/60; B65D 65/42; C09D 7/61; C09D 123/00; C09D 125/14; C09D 191/06; D21H 19/58; D21H 21/14; D21H 23/34; D21H 23/56

(52) U.S. Cl. CPC D21H 19/60; B65D 65/42; C09D 7/61; C09D 123/00; C09D 125/14; C09D 191/06; D21H 19/58; D21H 21/14; D21H 23/34; D21H 23/56

(57) ABSTRACT

The invention relates to a method for manufacturing a heat scalable barrier material (2), the method comprising: supplying a paper (10, 11) having a first side and a second side, applying a barrier coating dispersion on the first side of the paper by using a blade coater or a rod coater, the barrier coating dispersion being an aqueous dispersion having solids content in a range between 40 and 60 wt. % and comprising from 20 wt. % to 60 wt. % mineral pigment(s), and from 20 wt. % to 80 wt. % functional polymer(s) which are selected from a group consisting of: polyolefin dispersion(s), acrylate dispersion(s), styrene-acrylate dispersion(s), vinyl acetate-acrylate dispersion(s), and styrene-butadiene latex dispersion(s), and drying the barrier coating dispersion in order to form a barrier coating layer (20). The invention relates to a use of the heat sealable barrier material. The invention further relates to a package.

### TECHNICAL FIELD

The present invention relates to a heat sealable barrier material. The present invention relates to a method of manufacturing a heat sealable barrier material, and a package containing such heat sealable barrier material.

### BACKGROUND

In packaging industry, a large variety of paper-based materials are manufactured for packaging foodstuffs, such as bread, as well as for industrial wrapping applications, for example ream wrapping. Packaging in the above-mentioned applications may require barrier properties, such as water resistance, grease resistance and air permeability, for protecting the packed product from being affected by outside factors and/or preventing the features of packed product from losing. The properties and the desired shelf life of the products to be packaged typically determine the packaging material used for packaging each product. The packaging materials may vary between different products and also within the same product group. In industry, however, there is still need for new packaging materials and packages.

### SUMMARY

It is an aim of this specification to present a heat sealable barrier material. Furthermore, it is an aim of this specification to present a method for manufacturing a heat sealable barrier material.

Aspects of the invention are characterized by what is stated in the independent claims. Some preferred embodiments are disclosed in the dependent claims. These and other embodiments are disclosed in the description and figures.

A heat sealable barrier material may comprise or consist of
1) a paper comprising cellulose-containing natural fibers, and
2) a barrier coating layer on the first side of the paper.

The paper may comprise a coating layer on one or both sides of the paper. The coating layer may form an intermediate layer between the paper and the barrier coating layer.

The barrier coating layer can be obtained by applying a barrier coating dispersion comprising
from 20 wt. % to 60 wt. % (by dry weight) mineral pigment(s),
from 20 wt. % to 80 wt. % (by dry weight) functional polymer(s), and
optionally, one or more than one wax, on to a surface of the paper.

In an embodiment, the wax(es) is/are selected from a group consisting of polyolefin wax, paraffin wax, microcrystalline wax, bees wax, carnauba wax, rice bran wax, sugar cane wax, sunflower wax, and soy wax

The functional polymer(s) can comprise one or more than one polymer selected from a group consisting of:
polyolefin dispersion(s),
acrylate dispersion(s),
styrene-acrylate dispersion(s),
vinyl acetate-acrylate dispersion(s), and
styrene-butadiene latex dispersion(s).

These polymers can be able to provide heat sealability for the product, even if the barrier coating layer has up to 60 wt. % mineral pigments. Further, these polymers can be able to provide suitable barrier properties even if the barrier coating layer has up to 60 wt. % mineral pigments.

The barrier coating dispersion, as well as the barrier coating layer formed from the barrier coating dispersion, may comprise
from 20 wt. % to 60 wt. % (dry weight) mineral pigment(s), and
from 20 wt. % to 80 wt. % (dry weight) functional polymer(s), preferably at least 25 wt. % functional polymer(s).

Web speed in online blade and rod coating processes may be between 500 m/min and 2000 m/min, and often between 700 and 1500 m/min. Therefore, the barrier coating dispersion according to this specification can be adjusted to be applicable at least at this speed range. Thanks to the barrier coating dispersion comprising the functional polymer(s) and at least 20 wt. % mineral pigment(s), more preferably at least 25 wt. % mineral pigment(s), the barrier coating dispersion may be used in such coating processes having a web speed from 500 m/min to 2000 m/min, preferably from 700 m/min to 1500 m/min.

In an embodiment, the barrier coating dispersion as well as the barrier coating layer comprise from 30 wt. % to 60 wt. % (dry weight) mineral pigment(s), and from 30 wt. % to 70 wt. % (dry weight) functional polymer(s).

Thanks to the barrier coating layer on the paper, many advantages may be obtained. For example, it is possible to obtain heat sealable barrier material having good barrier properties as well as good dimensional stability and good strength properties. Said functional polymers may effectively provide suitable barrier and heat sealability properties. Still further, said functional polymers together with between 20 wt. % and 60 wt. % (dry weight) of mineral pigments in a barrier coating dispersion can provide increased high shear viscosity. Therefore, by using the barrier coating dispersion according to this specification, it may be possible to obtain an improved blade coater runnability. Furthermore, the barrier coating dispersion according to this specification may have increased solids content, providing improved drying efficiency for the coating layer. Moreover, paper based barrier materials can be environmentally friendly alternatives for replacing packaging materials made of plastics.

The barrier coating layer may have a coat weight from 4 to 10 g/m², preferably from 5 to 8 g/m². Thus, good barrier properties as well as suitable heat sealability may be obtained cost efficiently.

In an embodiment, an amount of the polyolefin dispersion(s) is at least 20 wt. %, preferably from 30 wt. % to 100 wt. % (dry weight), calculated from the total dry weight of the functional polymers. Polyolefin dispersion may provide very good heat sealability as well as an improved cracking resistance for the barrier layer. The polyolefin dispersion may comprise at least one of polyethylene and polypropylene.

The styrene-butadiene latex is a copolymer which can be composed of two different types of monomers. In an embodiment, an amount of the styrene-butadiene latex dispersion(s) is at least 20 wt. %, preferably from 30 wt. % to 100 wt. % (dry weight), calculated from the total dry weight of the functional polymers. The styrene-butadiene latex dispersion may provide good heat sealability as well as good humidity barrier. In this embodiment, the barrier coating dispersion preferably comprises a wax.

In an embodiment, an amount of the styrene-acrylate dispersion(s) is at least 20 wt. %, preferably from 30 wt. % to 100 wt. % (dry weight), calculated from the total dry weight of the functional polymers. The styrene-acrylate dispersion may provide particularly good humidity barrier. In this embodiment, the barrier coating dispersion preferably comprises a wax. In an embodiment, the functional polymers at least mainly consist of styrene-acrylate dispersion(s), and the barrier coating dispersion comprises from 20 wt. % to 30 wt. % (dry weight) mineral pigment(s).

In an embodiment, a total amount of the acrylate dispersion(s) is at least 20 wt. %, preferably from 30 wt. % to 100 wt. % (dry weight), calculated from the total dry weight of the functional polymers. The acrylate dispersion(s) may provide many benefits for the barrier layer including low water absorption and good UV resistance. Further, thanks to the acrylate dispersion(s), the barrier layer may be substantially odorless. Still further, the acrylate dispersion may not have strong effect on color of the barrier layer, hence, visual appearance of the barrier layer may be easily controlled. In this embodiment, the barrier coating dispersion preferably comprises a wax.

In an embodiment, a total amount of the vinyl acetate-acrylate dispersion(s) is at least 20 wt. %, preferably from 30 wt. % to 100 wt. % (dry weight), calculated from the total dry weight of the functional polymers. The vinyl acetate-acrylate dispersion(s) may provide good resistance to blistering. In this embodiment, the barrier coating dispersion preferably comprises a wax.

As discussed, the barrier coating layer can comprise mineral pigments in a range between 20 wt. % and 60 wt. %. In order to improve recyclability of the heat sealable barrier material, the amount of mineral pigment(s) can be at least 25 wt. %, and preferably at least 30 wt. %, calculated from total dry weight of the barrier coating layer.

The functional polymer(s) in the polymer dispersion may have a film forming temperature in a range between 60° C. and 100° C., preferably in a range between 8° and 95° C. Thanks to said film forming temperature, a fast film formability may be provided, which may be required in dispersion coating processes, particularly when a web speed of a coating process exceeds 700 m/min.

The functional polymer particles in the barrier coating dispersion can have a particle diameter of less than 1 μm, preferably equal to or less than 600 nm. Thus, uniformity of the formed barrier layer may be improved in dispersion coating processes.

The paper comprising cellulose-containing natural fibers may comprise
1) a base paper, and
2) optionally, an intermediate layer on the base paper.

If the paper comprises the intermediate layer, the barrier coating is preferably applied on to the intermediate layer. Thanks to the intermediate layer disposed between the base paper and the barrier coating layer, barrier properties of the barrier coating layer may be improved. Further, a thinner barrier coating layer may be needed to provide certain barrier properties. The intermediate layer may comprise, e.g., mineral pigment(s) and at least one binder.

A method for manufacturing a heat sealable barrier material may comprise the following steps:
supplying a paper comprising cellulose-containing natural fibers, the paper having a first side and a second side, and
applying a barrier coating dispersion on the first side of the paper by using a blade coater or a rod coater,
wherein the barrier coating dispersion is an aqueous dispersion having solids content in a range between 40 and 60 wt. % and comprising
   from 20 wt. % to 60 wt. % (dry weight) mineral pigments, and
   from 20 wt. % to 80 wt. % (dry weight) functional polymer(s) selected from a group consisting of polyolefin dispersion(s), acrylate dispersion(s), styrene-acrylate dispersion(s), vinyl acetate-acrylate dispersion(s), and a styrene-butadiene latex dispersion(s),
      and
drying the barrier coating dispersion into a barrier coating layer, thereby obtaining the heat sealable barrier material.

On paper machines, runnability of barrier dispersions on online coaters has been challenging. On these coater types, wet coating is applied in excess, and a metering element (blade or rod) is used to adjust the coat weight by removing the excess amount.

Reaching desired barrier properties requires sufficient coating thickness, while certain minimum level of rod or blade pressure must be maintained to ensure even coating profile in the cross direction. These conditions may be impossible to reconcile if the coating has too low viscosity at the shear rate occurring between the web and a metering element. Shear rate depends on the web speed and coating film thickness, being of the order of 106 1/s on a paper machine running at 800 m/min. Further, solids content of typical barrier dispersions is too low for the drying capacity of high speed online coaters, especially those using drying cylinders for final drying. Although cylinder section is usually preceded by contactless air and/or IR dryers, these might not have enough power to sufficiently dry a low-solids coating layer before it enters the cylinder section, where a still tacky coating has a risk to cause deposits on hot cylinder surfaces.

High shear viscosity and solids content can both be increased by adding mineral pigments to the coating formulation. Although beneficial for the coating process, high pigment loading can cause porosity and capillaries in the coating layer, providing pathways for permeating substances to bypass the barrier layer entirely. Moreover, coatings with high pigment loading have been unsuitable for heat sealing because pigment does not contribute to adhesion, causing low bond strength and high sealing temperature requirement, possibly making heat sealing impossible. Furthermore, unpigmented barrier coating dispersions have not been suitable for high-speed blade and rod coaters. Therefore, conventionally, it has been difficult to form a barrier coating layer cost efficiently by using a blade coater or a rod coater.

In order to economically operate, paper mills must be able to recycle broke internally. Pure polymer coating can negatively affect the recyclability of coated paper because it is more likely to form large particles than pigment containing coating when repulped.

Surprisingly, by selecting certain functional polymer(s) and optimizing pigment content of barrier coatings, good runnability was reached with a blade coater and a rod coater, without compromising barrier performance or heat sealability of the obtained heat sealable barrier material. Further, surprisingly, by using a barrier coating dispersion according to this specification, a uniform coating layer can be formed on the paper. Further, a decreased drying time can be achieved which consequently facilitates the manufactural efficiency. High shear viscosity as well as high solids content were both obtained by adding mineral pigments to certain functional polymer dispersions. Further, a better dimension stability of the paper web may be obtained because, thanks to the novel barrier coating dispersion, paper web may not wet as much as with many other kinds of water-based barrier dispersions.

Furthermore, the process of manufacturing the coated paper according to the specification may be a lot simplified. Often paper is transported from a paper mill to a converter who adds barrier material, for example by extruding a plastic film on a paper, and then the coated paper is again transported to another converter/printer for finalizing into a final product. The barrier coating layer according to this specification may be done at a paper mill and, hence, at least one converter step and transportation phase may be avoided.

The heat sealable barrier material according to the specification may be printable by a printing technique according to the state of art. Thus, the barrier coating layer may be arranged to be printable.

The heat sealable barrier material can be a packaging material. The heat sealable barrier material according to the specification may be used, e.g., in a food package. The barrier coating layer according to this specification may provide excellent water and moisture barrier properties, especially in high humidity. Thus, a packed product may be protected well e.g., from moisture.

### BRIEF DESCRIPTION OF THE DRAWINGS

In the following, the invention will be described in more detail with reference to the appended drawings, in which:

FIG. 1 shows, by way of an example, a heat sealable barrier material comprising a paper and a barrier coating layer,

FIG. 2 shows, by way of an example, a paper comprising an intermediate layer,

FIG. 3 shows, by way of an example, a heat sealable barrier material comprising a coated paper and a barrier coating layer,

FIG. 4 shows, by way of an example, a method for forming a heat sealable barrier material, and

FIG. 5 shows, by way of an example, a package comprising the heat sealable barrier material.

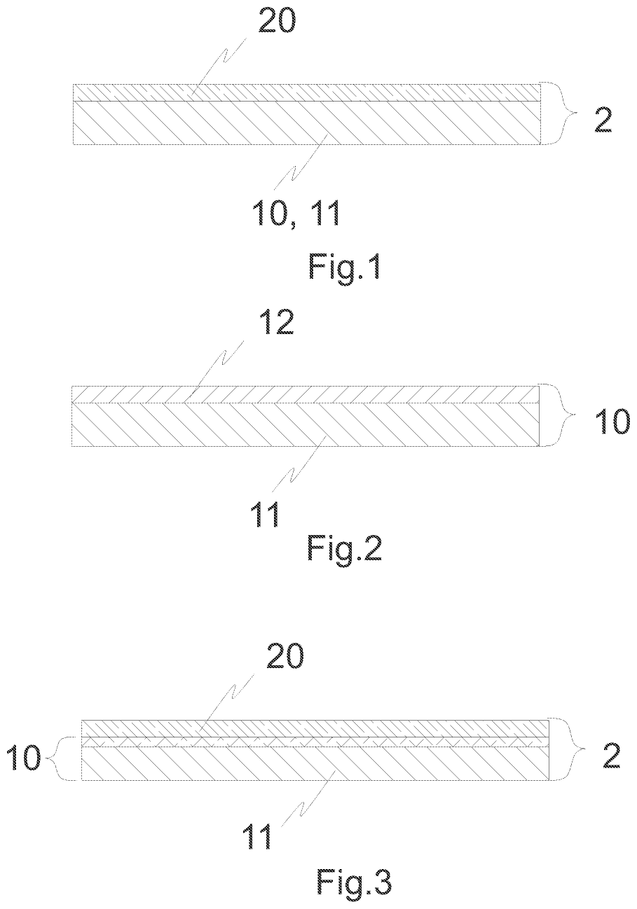

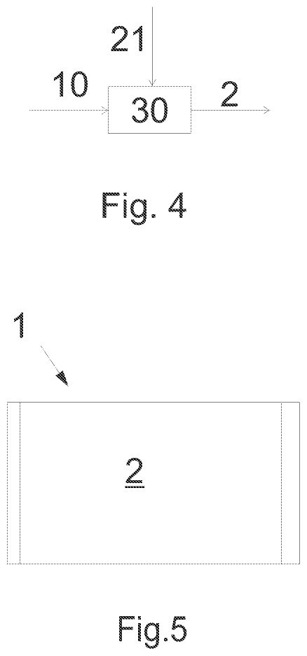

The Figures are intended to illustrate the general principles of the disclosed solution. Therefore, the illustrations in the Figures are not necessarily in scale or suggestive of precise layout of system components.

### DETAILED DESCRIPTION

The solution is described in the following in more detail with reference to some embodiments, which shall not be regarded as limiting.

In the text, references are made to the Figures with the following numerals and denotations:
1 package,
2 heat sealable barrier material,
10 paper,
11 base paper,
12 intermediate layer,
20 barrier coating layer,
21 barrier coating dispersion, and
30 coating unit.

The embodiments and examples recited in the claims and in the specification are mutually freely combinable unless otherwise explicitly stated.

In this specification, the term “comprising” may be used as an open term, but it also comprises the closed term “consisting of”. Thus, unless otherwise indicated, the word “comprising” can be read as “comprising or consisting of”.

For the purpose of the present description and the claims, unless otherwise indicated, all ranges include any combination of the maximum and minimum points disclosed, and include any intermediate ranges therein, which may or may not be specifically enumerated herein.

Percentage values relating to an amount of a material are percentages by dry weight (wt. %) unless otherwise indicated.

Term “web” refers to a continuous sheet of material. The web is generally processed by moving over rollers. Between processing stages, webs may be stored and/or transported as rolls.

Term “machine direction” (MD) refers to manufacturing direction of a web. Further, longitudinal direction of a web refers to the machine direction.

In case of a rolled web, machine direction refers to a circumferential direction of the roll.

Term “cross direction” (CD) refers to a direction that is transversal to the machine direction.

Term “gsm” refers to g/m².

Unless otherwise indicated, the following standards refer to methods which may be used in obtaining stated values of parameters representing quality of the heat sealable barrier material:

| | |
|---|---|
| Grammage | ISO 536, |
| Water absorption | ISO 535: Cobb 60 s, |
| WVTR | ISO 2528: 2017, |
| Thickness | ISO 534, |
| Brightness D65 | ISO 2470-2, |
| Opacity | ISO 2471, |
| Tensile index | ISO 1924-3: 2005, and |
| Grease penetration | ASTM F119-82: 2015. |

Grease penetration values as disclosed herein are measured according to standard ASTM F119-82 at a test temperature of 40° C. by using a chicken fat having a free fatty acids content of equal to or less than 1%.

The term “WVTR” stands for water vapour transmission rate, which is a mass of water vapour transmitted through a unit area in a unit time under specified conditions of temperature and humidity. The WVTR values as disclosed herein are be measured according to the standard ISO 2528:2017.

The term “WVTR 85%” refers to water vapour transmission rate, i.e., water vapour barrier, at conditions of RH 85%, temperature 23° C.

The term “WVTR 50%” refers to water vapour transmission rate, i.e., water vapour barrier, at conditions of RH 50%, temperature 23° C.

In this application, all the contents (percentages) are in dry weight, unless otherwise expressed.

In this application the term “pigment” can refer to mineral pigments. Examples of mineral pigments include kaolin, talc, PCC, and GCC.

The terms “PCC” and “GCC” refer to calcium carbonates. The term “PCC” refers to precipitated calcium carbonate, and the term “GCC” refers to ground calcium carbonate.

The term “SA” refers to styrene-acrylate (dispersion).

The term “SB” refers to styrene-butadiene latex (dispersion).

In this specification, the term “barrier coating layer” refers to a dried barrier coating dispersion. Thus, the barrier coating layer can have the same amounts of the functional polymer(s) (by dry weight) and the pigment(s) (by dry weight), as well as any other (optional) component(s), as is disclosed for the barrier coating dispersion.

The term “blade coater” refers to a device comprising an applicator, such as a jet or a roll, used for spreading the coating color on the paper web, and a blade, used for adjusting (metering) the coat weight. Typically, the blade coater first applies a layer of a coating on to a paper and then a blade of a blade coater is used to scrape an excess coating away, thereby leaving a desired amount of coating on the paper.

The term “rod coater” refers to a coater comprising a rod instead of the blade.

The blade of the blade coater or the rod of the rod coater may be made of a metal, or it may contain a polymer tip.

The above discussed methods are efficient methods for providing good quality coating. Furthermore, thanks to these methods, an evenness of the surface of the coating may be improved, which may improve heat sealability as well as a quality of the product. Most preferably, the coating device according to this specification comprises the blade coater.

The heat sealable barrier material 2 comprises or consists of
a paper 10, and
a barrier coating layer 20 on the paper 10.

### Paper

A purpose of the paper can be to provide cost efficiently substantially dimensionally stable surface, on which a coating on one or both sides may be applied.

The paper 10 may comprise or consist of
a base paper 11, and
optionally, an intermediate layer 12 on the base paper 11.

Therefore, the paper 10 may be a coated paper.

The base paper 11 may comprise natural fibres as its main raw material, and one or more fillers and/or additives.

The term ‘natural fiber’ refers to any plant material that contains cellulose.

The natural fiber may be of wood origin, and/or it may comprise other than wood-based natural fibers. Other than wood-based raw materials may include agricultural waste, grasses and/or other plant materials, such as straw, leaves, bark, seeds, legumes, flowers, tops, or fruit, which may have been obtained from cotton, corn, wheat, oat, rye, barley, rice, flax, hemp, manila hemp, sisal hemp, jute, ramee, kenaf hemp, bagasse, bamboo, and/or reed.

Preferably, the base paper 11 comprises natural fibers which are of wood origin. The paper may comprise fibers from softwood trees, such as spruce, pine, fir, larch, douglas-fir, or hemlock, or from hardwood trees, such as birch, aspen, poplar, alder, eucalyptus, or acacia, or from a mixture of softwoods and hardwoods.

In an embodiment, the base paper 11 comprises a chemical pulp, such as bleached kraft pulp. Amount of the chemical pulp may be equal to or more than 10 wt. %, preferably in a range between 50 wt. % and 100 wt. %, more preferably in a range between 70 wt. % and 90 wt. %, calculated from total dry weight of the natural fibers. The technical effect is to improve strength properties of the heat sealable material.

The paper may comprise bleached mechanical pulp (GW, PGW, TMP, CTMP) in a range between 0 and 50 wt. %, more preferably from 4 wt. % to 30 wt. %, calculated from total dry weight of the natural fibers. Preferably the mechanical pulp is bleached CTMP (bleached chemi-thermomechanical pulp).

In an embodiment, the paper comprises bleached chemi-thermomechanical pulp (bleached CTMP) in a range between 4 and 30 wt. %, more preferably in a range between 6 wt. % and 20 wt. %, and most preferably in a range between 8 wt. % and 16 wt. %, calculated from total dry weight of the fibers. The technical effect of using mechanical pulp, and particularly bleached CTMP, is to increase bulk and opacity of the paper.

For environmental reasons, the paper may comprise recycled fibers (RCF). The paper may comprise recycled cellulose-containing natural fibers from 0 wt. % up to 50 wt. %, preferably from 0 to 30 wt. %, determined from all fiber sources in the paper. The paper may comprise recycled fibers, e.g., in a range between 5 wt. % and 25 wt. %, calculated from the total weight of the fibers in the paper. Thus, it may be possible to decrease manufacturing costs of the heat sealable barrier material 2. Further, the usage of the recycled fibers may reduce amount of virgin fibers in the paper, hence, this may be environmentally friendly solution.

However, in some cases, virgin fibers may be more preferrable for the heat sealable barrier material than recycled fibers. With virgin fibers, it may be possible to improve some properties, such as strength and brightness properties, of the heat sealable barrier material. With virgin fibers, it may be easier to obtain some properties compared to products with recycled fibers. Therefore, in an embodiment, the paper does not comprise said recycled fibers.

The base paper 11 may comprise mineral fillers, preferably in a range between 0 wt. % and 25 wt. %, more preferably in a range between 5 wt. % and 20 wt. %, and most preferably equal to or less than 15%, calculated from the total weight of the base paper 11. The usage of the mineral fillers may improve some optical properties of the paper as well as decrease the manufacturing costs of the heat sealable barrier material 2. However, the mineral filler content of the heat sealable barrier material may not be too high in order to obtain suitable properties for the heat sealable barrier material. For example, strength properties of the heat sealable barrier material typically improve as the amount of mineral fillers decreases. Mineral fillers may comprise, for example, clay, natural ground calcium carbonate, precipitated calcium carbonate, talc, calcium sulphate, and/or titanium dioxide.

As discussed, the heat sealable barrier material may comprise an intermediate coating layer 12. The intermediate coating layer 12 may comprise at least one binder and one or more pigments. In an embodiment, the binder(s) may be selected from a group comprising styrene-acrylate latex, styrene-butadiene latex, vinyl acetate-acrylate latex, polyvinyl alcohol, and (modified) starch. The pigment(s) of the intermediate coating layer may be selected from a group comprising, e.g., calcium carbonate (GCC/PCC), kaolin clay, talc, and/or mica.

The intermediate layer 12 may be situated between the base paper 11 and the barrier coating layer 20. Thanks to the intermediate layer 12, a surface of the paper 10 may have improved smoothness. Therefore, fibers on the paper surface may not puncture the barrier coating layer in blade or rod coatings easily. Thus, pinholes, causing e.g. moisture and grease penetrating the paper and the coating, may be avoided, or at least diminished.

In an advantageous embodiment, the paper 10 consists of the base paper 11 and the intermediate coating layer 12 on one or both sides of the base paper 11. Thus, it is possible to provide a support layer having good strength, suitable dimensional stability, and an even surface for the barrier coating layer.

It may be good for manufacturing and transportation costs to reduce the grammage of the paper 10 for reducing weight of the heat sealable barrier material and, thus, the weight of a package. However, typically paper having less grammage is also thinner and may have reduced strength, heat sealability and barrier properties.

Thus, the grammage of the paper 10 is advantageously at least 35 gsm, more advantageously at least 40 gsm and preferably not greater than 130 gsm. The grammage of the paper 10 may be, for example, in a range between 40 gsm and 120 gsm. In an advantageous example, the grammage of the paper is between 45 gsm and 110 gsm. Thus, it is possible to provide good barrier, heat sealability and strength properties while the heat sealable barrier material may be environmentally friendly solution due to the minimum amount of raw materials needed for the package.

### Barrier Coating Dispersion

The barrier coating layer 20 can be formed from a barrier coating dispersion 21. The barrier coating dispersion can comprise functional polymer(s) and mineral pigment(s). Thus, the barrier coating dispersion 21 can comprise one or more than one functional polymer and one or more than one mineral pigment. Furthermore, the barrier coating dispersion 21 may comprise at least 5 wt. % wax(es) for adjusting properties of the barrier coating dispersion.

As discussed, the barrier coating dispersion may have from 20 to 80 wt. % (by dry weight) functional polymer(s). The technical effect of the functional polymer(s) is to provide good heat sealability together with suitable barrier properties.

Further, as discussed, the barrier coating dispersion may have 20 to 60 wt. % mineral pigment(s), determined from dry weight of the barrier coating dispersion. The technical effect is to control and/or increase shear viscosity of the barrier coating dispersion. This may improve controllability of the formed coating as well as improve runnability of blade and rod coaters.

Further, the mineral pigments may improve recyclability of the heat sealable barrier material.

The functional polymer(s) and mineral pigment(s) may form at least 70 wt. % (by dry weight), preferably at least 80 wt. % (by dry weight) of the barrier coating dispersion 21 and, hence, of the barrier coating layer 20.

The barrier coating dispersion is water-based dispersion. Handling of solvent free dispersions may be easier than handling of solvent-based coatings. Further, water-based dispersions can be environmentally friendly alternatives for solvent-based coatings.

The functional polymer(s) can be selected from a group consisting of polyolefin dispersion(s), acrylate dispersion(s), styrene-acrylate dispersion(s), vinyl acetate-acrylate dispersion(s), and styrene-butadiene latex dispersion(s). Therefore, the functional polymer(s) may consist of one or more of the following: polyolefin dispersion(s), acrylate dispersion(s), styrene-acrylate dispersion(s), vinyl acetate-acrylate dispersion(s), and styrene-butadiene latex dispersion(s). These polymers may be used for forming reliable heat sealability and good barrier properties when used together with at least 20 wt. % of mineral pigments. Furthermore, the barrier coating dispersion comprising said one or more functional polymers together with at least 20 wt. % of mineral pigments can be suitable for coating processes having a web speed from 500 m/min to 2000 m/min, preferably from 700 m/min to 1500 m/min.

Preferably, the functional polymer(s) are selected from a group consisting of polyolefin dispersion(s), styrene-acrylate dispersion(s), and styrene-butadiene latex dispersion(s). These polymer dispersions can be used to provide cost efficiently a barrier coating layer having a good heat sealability. Further, said polymer dispersions can have improved runnability together with mineral pigments and, hence, they can be used for improving production efficiency of the rod and blade coating processes.

In an embodiment, polymer particles in the barrier coating dispersion have a particle diameter of less than 2 μm, preferably equal to or less than 1 μm, more preferably equal to or less than 600 nm, and most preferably equal to or less than 400 nm. Thanks to said particle size, uniformity and/or integrity of the formed barrier layer may be improved.

The barrier coating dispersion may comprise wax(es). Amount of the wax(es) is preferably at least 5 wt. % and 70 wt. % at the most, more preferably in a range between 10 and 50 wt. %, and most preferably in a range between 15 and 30 wt. %, determined from combined dry weight of waxes and functional polymers in the barrier coating dispersion.

The wax content, determined as total dry weight of waxes per total dry weight of the barrier coating dispersion, is preferably in a range between 2 wt. % and 56 wt. %, more preferably between 4 wt. % and 40 wt. %, most preferably between 6 wt. % and 24 wt. %, from the total dry weight of the barrier coating dispersion.

The wax(es), if used, may comprise at least one of
bio-based waxes such as bees wax, carnauba wax, rice bran wax, sunflower oil wax,
bio-based or synthetic Fischer-Tropsch waxes, and
synthetic waxes such as paraffin or polyethylene waxes.

In an advantageous embodiment, the at least one wax is selected from a group consisting of polyolefin wax, paraffin wax, microcrystalline wax, bees wax, carnauba wax, rice bran wax, sugar cane wax, sunflower wax and soy wax. The wax(es) can be used to modify physical properties of used polymer(s).

In order to form a good barrier layer on the paper, the functional polymer(s) in the polymer dispersion can be selected or adjusted (e.g., by waxes) to have a melting point and/or a film forming temperature in a range between 60° C. and 95° C. Low enough melting point enables fast film forming, which may be required in dispersion coating processes. Said temperature may be needed to obtain a good barrier coating layer by using a blade coater or a rod coater at a paper machine. Thus, the barrier coating may comprise polymeric material suitable to be used at typical process temperatures in dispersion coating of a paper machine.

Furthermore, the functional polymer(s) may be selected or adjusted (e.g., by additives, such as plasticizers) to have a glass transition temperature at equal to or below 23° C. Thanks to said glass transition temperature, flexibility of the barrier coating may be improved so that the heat sealable barrier material comprising said coating may be, e.g., folded into a pouch or a wrapper so that the barrier coating is not broken but maintains its barrier properties. Therefore, the barrier coating layer may not be easily broken during usage of the heat sealable barrier material. Below glass transition temperature, polymers are typically rigid and brittle (glass-like). Preferably, the glass transition temperature is lower than ambient temperature during a typical usage of the heat sealable barrier material. Thus, the barrier coating layer may not crack too easily during usage and, hence, the barrier coating layer may maintain its barrier properties.

As discussed, the barrier coating dispersion comprises mineral pigment(s) in a range between 20 wt. % and 60 wt. % (by dry weight). The barrier coating dispersion may comprise mineral pigment(s) in a range between 25 wt. % and 55 wt. %, and more preferably in a range between 30 wt. % and 50 wt. %, calculated from the total dry weight of the barrier coating dispersion. The usage of the pigments may improve many properties of the heat sealable barrier material as well as decrease the manufacturing costs of the product and improve recyclability properties of the heat sealable barrier material.

Thanks to the novel solution having certain functional polymer(s) and mineral pigment(s), mineral content of the barrier coating dispersion may be substantially high while still providing good barrier properties for the obtained product. Often, a poor shear viscosity rate can be a problem at blade and rod coaters. Thanks to the pigment(s) together with certain functional polymer(s), shear viscosity of the barrier coating dispersion may be controlled so that the barrier coating dispersion can be used in blade and rod coaters. Further, by using at least 25 wt. %, preferably at least 30 wt. %, and most preferably at least 35 wt. % pigments (by dry weight), easiness of recyclability of the heat sealable barrier material may be improved.

The mineral pigment(s) may comprise one or more than one from the following group: kaolin, mica, natural ground calcium carbonate (GCC), precipitated calcium carbonate (PCC), talc, calcium sulphate, and titanium dioxide. By adding mineral pigment(s), runnability on blade and rod coaters may be improved. These pigments can provide, when combined with the functional polymers, good barrier properties. Furthermore, these pigments may reduce costs of the produced heat sealable barrier material. Moreover, by adding these pigments into the barrier coating dispersion, the heat sealable barrier material may have improved recyclability. Particularly, barrier coating layers comprising at least 25 wt. %, preferably at least 30 wt. %, and most preferably at least 35 wt. % pigments (by dry weight), may have improved recyclability compared to conventional barrier coatings.

Platy pigment, such as kaolin, talc, or mica, can be advantageous for the barrier coating layer as the platy, flaky structure, when piling inside the coating layer, forms more difficult paths for small penetrants to travel as compared to cubic- or spherical-shaped pigments, thus contributes barrier properties.

In an embodiment, precipitated calcium carbonate (PCC) is used as the mineral pigment in the barrier coating layer. Properties of PCC can be adjusted to obtain suitable barrier properties.

Thanks to the novel solution, solids content of the barrier coating dispersion may be increased by using mineral pigment(s) and suitable functional polymer(s) in barrier coating dispersion. Solids content of the barrier coating dispersion, to be applied on the paper, can be in a range between 40% and 60%, preferably in a range between 45% and 55%, measured from total weight of the barrier coating dispersion. Thus, drying efficiency, and hence production efficiency, may be substantially improved.

The barrier coating layer may have a coat weight from 4 gsm to 10 gsm, preferably from 5 gsm to 8 gsm (by dry weight). Surprisingly, the barrier coating having said pigment content and functional polymer content as well as such a grammage, can show a combination of suitable water vapor barrier for many applications, e.g., for food packaging, as well as suitable film formation at typical temperatures of paper machines.

Thus, grammage of the barrier coating layer may be at least 4 gsm, more preferably at least 4.5 gsm, and most preferably equal to or more than 5 gsm. Thus, a barrier coating layer having good barrier properties may be obtained.

Further, grammage of the barrier coating layer may be equal to or less than 10 gsm, more preferably equal to or less than 9 gsm, and most preferably equal to or less than 7 gsm (by dry weight). Thus, it is possible to manufacture a barrier coating layer having improved barrier properties cost efficiently. Preferably, the barrier coating layer 20 consists of a single coating layer. Thus, it may be possible to produce a heat sealable barrier material 2 having improved properties in a cost-effective process.

As discussed above, the barrier coating layer comprises functional polymer(s) and pigment(s). The functional polymer(s) may provide a heat sealability and pinhole-free structure for obtaining barrier properties. Thus, thanks to the novel solution, pinholes may be avoided. Further, the pigment(s) may provide suitable shear viscosity rate for the barrier coating dispersion so that the barrier coating dispersion may be efficiently used in rod and blade coaters at a paper machine.

### Heat Sealable Barrier Material

Thanks to the novel solution, it may be possible to influence and/or control a water vapour transmission rate, oxygen transmission rate, adherence of the barrier coating to paper, grease resistance, and a number of pinholes of the heat sealable barrier material.

As discussed, the barrier coating layer 20 may comprise the same amounts of mineral pigment(s) and functional polymer(s) (by dry weight) as the barrier coating dispersion 21. Thus, the barrier coating layer comprises from 20 wt. % to 60 wt. % mineral pigment(s), and from 20 to 80 wt. % (by dry weight) functional polymer(s).

The heat sealable barrier material comprising the paper and the barrier coating layer may have a grammage of at least 30 gsm, preferably at least 40 gsm, and more preferably at least 50 gsm. Further, the heat sealable barrier material may have a grammage equal to or less than 155 gsm, preferably equal to or less than 130 gsm, and more preferably equal to or less than 120 gsm. The grammage of the heat sealable barrier material may advantageously be e.g. in a range between 60 gsm and 110 gsm. Thus, it may be possible to obtain heat sealable barrier material having improved properties.

The heat sealable barrier material can consist of the paper 10 and the barrier coating layer 20. The paper may be a coated paper, the coated paper having the base paper 11 and the intermediate layer 12 on the base paper. Thus, the heat sealable barrier material may comprise or consist of a barrier coating layer on at least one side of the paper.

Preferably, the paper 10 is a sized and/or the coated paper. Thus, it is possible to achieve full surface coverage with lower coat weight of the barrier coating.

The heat sealable barrier material 2 may have water vapour transmission rate (WVTR 85%) of less than 200 g/m²/d, measured at 23° C./85% RH. The heat sealable barrier material 2 can have water vapour transmission rate (WVTR 85%) of less than 150 g/m²/d, preferably less than 100 g/m²/d, more preferably less than 80 g/m²/d, and most preferably equal to or less than 50 g/m²/d, measured at 23° C./85% RH, to protect the packaged product. In an embodiment, the water vapour transmission rate (WVTR 85%) is equal to or more than 0 g/m²/d.

The heat sealable barrier material 2 can have a tensile index in machine direction (determined according to standard ISO 1924-3:2005) in a range between 50 Nm/g and 110 Nm/g, more preferably at least 60 Nm/g, and most preferably at least 70 Nm/g. The heat sealable barrier material 2 can have a tensile index in cross direction (determined according to standard ISO 1924-3:2005) in a range between 20 Nm/g and 60 Nm/g, more preferably at least 25 Nm/g, and most preferably at least 28 Nm/g. These strength values may be particularly suitable for heat sealable barrier materials to be used in a food package.

The heat sealable barrier material 2 may provide good water resistance (Cobb (60 s)) of less than 10 g/m², preferably less than 5 g/m², and most preferably less than 1 g/m².

The heat sealable barrier material 2 may provide a good seal strength above 3 N/15 mm, preferably above 4 N/15 mm, and more preferably above 5 N/15 mm, tested by cutting 15×120 mm specimen from the heat sealable barrier material 2 and sealing them coating vs. coating according to ASTM F2029-16. Sealing parameters are temperature of 120° C., jaw pressure of 3 bar, and dwell time of 0.5 s. Seal strength is measured with a tensile tester according to ASTM F88/F88M-15. Thus, the heat sealable barrier material 2 may provide good heat sealability.

Still further, the heat sealable barrier material 2 may provide an improved grease resistance for at least 1 day, preferably at least 2 days, more preferably at least 3 days. Thus, the grease resistance of the heat sealable barrier material 2 may be, for example, equal to or more than 1 d, more preferably equal to or more than 2 d, and most preferably equal to or more than 3 days. The grease resistance may be, for example, in a range between 0 d and 7 d, or between 1 d and 5 d.

Thus, the heat sealable barrier material 2 and the package 1 may protect the packaged product from water and/or grease and/or from water vapour.

Further, the heat sealable barrier material with the barrier coating layer can be recyclable, despite of these excellent properties.

### Manufacturing Method

The barrier coating layer 20 can be made by using a dispersion coating technique. In this specification, dispersion coating refers to a coating technique in which an aqueous dispersion comprising functional polymer particles is applied to a surface of a paper to form a solid coating layer after drying.

In a preferred embodiment, the paper is the coated paper, i.e., the heat sealable barrier material preferably has the intermediate coating layer between the base paper and the barrier coating layer. Fibers of the paper may decrease barrier properties if the paper is a rough paper.

The barrier coating dispersion may be applied by using a coating unit 30. The coating unit may comprise one or more coating devices. The coating unit 30 can be a dispersion coating unit comprising a blade coater or a rod coater.

The barrier coating dispersion may be applied on the paper 10 by using a blade coating or a rod coating technique, wherein the blade or the rod is directly in contact with the barrier coating dispersion, and there may be a backing roll on the second side of the paper. Thanks to the barrier coating dispersion according to this specification, improved runnability of the coating allows production of a heat sealable barrier material directly at a paper mill, hence, decreasing manufacturing cost because additional converting step is not needed. Further, the direct coating method comprising a blade or a rod as a metering element can improve an evenness of the surface of the heat sealable barrier material. Still further, the direct coating method may provide some improved properties for the heat sealable barrier material.

A method for manufacturing a heat sealable barrier material may comprise the following steps:
supplying a paper comprising cellulose-containing natural fibers, the paper having a first side and a second side, and
applying an aqueous barrier coating dispersion comprising a mineral pigment and a functional polymer on the first side of the paper, and
drying the barrier coating dispersion on the first side of the paper.

The barrier coating dispersion according to the specification can be suitable for online and offline blade and rod coaters. Thus, in an embodiment, the dispersion coating unit is an online coater for improving production efficiency of the heat sealable barrier material.

### EXPERIMENTAL TESTS

### Example 1

Laboratory scale screening of commercial barrier coatings was done by applying each coating on a sized 55 gsm wood free paper using a common drawdown rod coater. Coating was dried using a hot air blower, heating the paper surface to 90-100° C.

Barrier performance was evaluated by measuring water vapor transmission rate (WVTR) at 23° C./85% RH with a gravimetric method, according to ISO 2528:2017.

Heat sealability was tested by cutting 15×120 mm specimen from the coated papers and sealing them coating vs. coating (A-A) with a laboratory heat sealing device, according to ASTM F2029-16. Sealing parameters were temperature of 120° C., jaw pressure of 3 bar, and dwell time of 0.5 s. Seal strength was then measured with a tensile tester according to ASTM F88/F88M-15.

Good polymers exhibited sealing strength above 3 N/15 mm, preferably above 4 N/15 mm, more preferably above 5 N/15 mm. For some end uses, good polymers had WVTR of less than 50 g/m²/d, preferably less than 20 g/m²/d at 23° C./85% RH.

After verifying the barrier performance of the pure binders, common pigments were added in amounts of 20 or 40% of all solids, to study their effects on humidity barrier and heat sealability.

Dispersion A had best heat sealability but highest WVTR. Dispersion B was best humidity barrier but had weakest sealing. Dispersions C and D were good in both properties, but some barrier properties of dispersion C were decreased when more than 20% pigment was added. Other dispersions could accommodate at least 40% pigment while retaining good barrier, and dispersion A even seemed to benefit from pigment. Surprisingly, 40% of pigment did not have significant impact on heat sealability with any dispersion.

TABLE 1

| | | | Coat | | Seal |
|---|---|---|---|---|---|
| Polymer | Polymer | | weight | WVTR 85% | strength |
| ID | type | Pigment | (g/m²) | (g/m²/d) | (N/15 mm)* |
| A | Polyolefin | none | 7.4 | 29 | 6.6 |
| | | 40% kaolin | 9.5 | 27 | — |
| | | 40% talc | 9.3 | 12 | — |
| | | 40% GCC | 9.8 | 15 | 4.8 |
| B | SA 1 + | none | 5.0 | 4.8 | 3.6 |
| | wax 1 | 40% kaolin | 6.7 | 12.0 | 2.4 |
| | | 40% talc | 7.8 | 9.4 | 3.4 |
| | | 40% GCC | 7.6 | 17.0 | 2.6 |
| C | SA 2 + | none | 4.4 | 16 | 5.3 |
| | Wax 2 | 20% kaolin | 5.1 | 22 | 4.7 |
| | | 20% GCC | 5.2 | 21 | 4.8 |
| | | 40% kaolin | 6.9 | 37 | 5.3 |
| | | 40% GCC | 6.8 | 36 | 5.1 |
| D | SB + wax | none | 3.1 | 13 | 4.7 |
| | | 40% kaolin | 7.9 | 21 | 5.6 |
| | | 40% GCC | 8.6 | 14 | 5.5 |

*at 120° C., 3 bar, 0.5 s

### Example 2: Pilot Coatings

Selected polymers A-D were formulated with common pigments (kaolin clay, talc, calcium carbonate). Coating colors were applied on the same paper used in Example 1 on a pilot scale reel-to-reel blade coater. Web speed was 800 m/min, and infrared and air dryers were used to dry the coating, following practices commonly known in the field. Barrier properties were evaluated by measuring Cobb water absorption during 60 s (according to ISO 535), water vapor transmission rate (WVTR) at 23° C./50% RH and 23° C./85% RH (according to ISO 2528:2017), and grease penetration time at 40° C. (according to ASTM F119-82:2015).

The results are shown in Table 2 below.

TABLE 2

| | | coat | coating | Cobb | WVTR | WVTR | Grease |
|---|---|---|---|---|---|---|---|
| Polymer | | weight | thickness | 60 s | 50% | 85% | resistance |
| ID | Coating type | (g/m2) | (μm) | (g/m²) | (g/m²/d) | (g/m²/d) | (d) |
| A | PO + 40% kaolin | 7 | 4.4 | 3.9 | 9.3 | 110 | 1.0 |
| | PO + 40% talc | 5.3 | 3.3 | 1.8 | 8.7 | 90 | 1.0 |
| | PO + 40% GCC | 5.7 | 3.6 | 1.8 | 8.5 | 100 | 1.2 |
| | PO + 60% GCC | 7.3 | 3.8 | 1.9 | 8.3 | 110 | 1.0 |
| B | SA1 + wax1 + | 4.5 | 2.8 | 2.3 | 6 | 34 | 1.0 |
| | 40% kaolin | | | | | | |
| | SA1 + 40% talc | 3.6 | 2.3 | 2.4 | 5.6 | 35 | 1.0 |
| C | SA2 + wax2 | 4.3 | 4.3 | 0.92 | 6.3 | 53 | 1.8 |
| | SA2 + wax2 + | 6.3 | 3.9 | 1.8 | 12 | 110 | 1.2 |
| | 40% kaolin | | | | | | |
| | SA2 + wax2 | 5.7 | 5.7 | 0.38 | 4.9 | 30 | 2.2 |
| | primer + SA2 + | 5.1 | 5.1 | 0.36 | 6.7 | 26 | 3.0 |
| | wax2 | | | | | | |
| | primer + SA2 + | — | — | 0.08 | 4.2 | 16 | 3.8 |
| | wax2 + 20% | | | | | | |
| | GCC | | | | | | |
| D | SB + wax + 40% | 7.3 | 4.6 | 6.8 | 6.5 | 59 | 1.0 |
| | kaolin | | | | | | |
| | SB + wax + 40% | 7.1 | 4.4 | 2.5 | 7 | 79 | 1.0 |
| | talc | | | | | | |
| | SB + wax + 40% | 6.3 | 3.9 | 8.4 | 5 | 89 | 1.0 |
| | GCC | | | | | | |
| | SB + wax + 60% | 6.1 | 3.2 | 9.4 | 14 | 160 | 1.0 |
| | GCC | | | | | | |

Surprisingly, by selecting suitable functional polymer(s) and optimizing pigment content of barrier coating dispersion, good runnability and sufficient coat weight can be reached even with a blade coater, without compromising barrier performance or heat sealability.

For some test points, properties of the barrier coating layer were further improved by adding wax to the barrier coating dispersion. The novel solution may provide an improved runnability while maintaining good barrier performance and heat sealability. Further, surprisingly, it was possible to use up to 60% of pigments for the barrier coating layer and still obtain suitable heat sealability and barrier properties for the barrier coating layer.

The invention is not limited solely to the examples presented in Figures and the above description, but it may be modified within the scope of the appended claims.

1. A method for manufacturing a heat sealable barrier material, the method comprising:
supplying a paper comprising cellulose-containing natural fibers, the paper having a first side and a second side,
applying a barrier coating dispersion on the first side of the paper by using a blade coater or a rod coater,
the barrier coating dispersion being an aqueous dispersion having solids content in a range between 40 and 60 wt. % and comprising
from 20 wt. % to 60 wt. % (by dry weight) mineral pigment(s), and
from 20 wt. % to 80 wt. % (by dry weight) functional polymer(s) which are selected from a group consisting of: polyolefin dispersion(s), acrylate dispersion(s), styrene-acrylate dispersion(s), vinyl acetate-acrylate dispersion(s), and styrene-butadiene latex dispersion(s),
and
drying the barrier coating dispersion in order to form a barrier coating layer, thereby obtaining the heat sealable barrier material-+29.

2. The method according to claim 1, wherein a speed of the paper is in a range between 500 m/min and 2000 m/min when the barrier coating dispersion is applied on the first side of the paper.

3. A heat sealable barrier material obtainable by the method according to claim 1.

4. A heat sealable barrier material comprising:
a paper comprising cellulose-containing natural fibers, the paper having a first side and a second side, and
a barrier coating layer on the first side of the paper,
wherein the barrier coating layer comprises
from 20 wt. % to 60 wt. % (by dry weight) mineral pigment(s), and
from 20 wt. % to 80 wt. % (by dry weight) functional polymer(s) selected from a group consisting of: polyolefin dispersion(s), acrylate dispersion(s), styrene-acrylate dispersion(s), vinyl acetate-acrylate dispersion(s), and styrene-butadiene latex dispersion(s).

5. The heat sealable barrier material according to claim 4, wherein the barrier coating layer comprises at least 20 wt. % polyolefin dispersion(s) (by dry weight), calculated from the dry weight of the functional polymers.

6. The heat sealable barrier material according to claim 4, wherein the barrier coating layer comprises
at least 20 wt. % acrylate dispersion(s) (by dry weight), calculated from the dry weight of the functional polymers, and
optionally one or more than one wax.

7. The heat sealable barrier material according to claim 4, wherein the barrier coating layer comprises
at least 20 wt. % (by dry weight) styrene-acrylate dispersion(s), calculated from the dry weight of the functional polymers, and
optionally one or more than one wax.

8. The heat sealable barrier material according to claim 4, wherein the barrier coating layer comprises
at least 20 wt. % (by dry weight) vinyl acetate-acrylate dispersion(s), calculated from the dry weight of the functional polymers, and
optionally one or more than one wax.

9. The heat sealable barrier material according to claim 4, wherein the barrier coating layer comprises
at least 20 wt. % (by dry weight) the styrene-butadiene latex dispersion(s), calculated from the dry weight of the functional polymers, and
optionally one or more than one wax.

10. The heat sealable barrier material according to claim 4, wherein
the barrier coating layer comprises mineral pigments at least 25 wt. %, calculated from total dry weight of the barrier coating layer, and/or
the barrier coating layer has a coat weight from 4 to 10 g/m², and/or
the mineral pigment(s) and the functional polymer(s) form at least 50 wt % (by dry weight) determined from the barrier coating layer.

11. (canceled)

12. (canceled)

13. (canceled)

14. (canceled)

15. The method of the heat sealable barrier material according to claim 4, wherein
the paper comprises a base paper and an intermediate coating layer, and the barrier coating layer is formed on to the intermediate coating layer.

16. The heat sealable barrier material according to claim 4, wherein
the barrier coating layer comprises one or more than one wax, the amount of the wax(es) being at least 2 wt. % (by dry weight), calculated from total dry weight of the barrier coating dispersion, and
at least one of the wax(es) is selected from a group consisting of polyolefin wax, paraffin wax, microcrystalline wax, bees wax, carnauba wax, rice bran wax, sugar cane wax, sunflower wax, and soy wax.

17. A package comprising the heat sealable barrier material according to claim 4.

18. (canceled)

19. The method according to claim 1, wherein the barrier coating layer comprises at least 20 wt. % polyolefin dispersion(s) (by dry weight), calculated from the dry weight of the functional polymers.

20. The method according to claim 1, wherein the barrier coating layer comprises at least 20 wt. % acrylate dispersion(s) (by dry weight), calculated from the dry weight of the functional polymers, and one or more than one wax.

21. The method according to claim 1, wherein the barrier coating layer comprises at least 20 wt. % (by dry weight) styrene-acrylate dispersion(s), calculated from the dry weight of the functional polymers, and one or more than one wax.

22. The method according to claim 1, wherein the barrier coating layer comprises at least 20 wt. % (by dry weight) vinyl acetate-acrylate dispersion(s), calculated from the dry weight of the functional polymers, and one or more than one wax.

23. The method according to claim 1, wherein the barrier coating layer comprises at least 20 wt. % (by dry weight) the styrene-butadiene latex dispersion(s), calculated from the dry weight of the functional polymers, and one or more than one wax.

24. The method according to claim 1, wherein
the barrier coating layer comprises at least 25 wt. % mineral pigments calculated from total dry weight of the barrier coating layer, and/or
the mineral pigment(s) and the functional polymer(s) form at least 50 wt. % (by dry weight) determined from the barrier coating layer.

25. The method according to claim 1, wherein the functional polymer(s) in the barrier coating dispersion have a particle diameter of less than 1 μm.

26. The method according to claim 1, wherein the functional polymer(s) in the barrier coating dispersion have a film forming temperature in a range between 60° C. and 100° C.

27. The method according to claim 1, wherein
the paper comprises a base paper and an intermediate coating layer, and the barrier coating layer is formed on to the intermediate coating layer, and/or
the barrier coating layer has a coat weight from 4 to 10 g/m².

28. The method according to claim 1, wherein
the barrier coating layer comprises one or more than one wax, the amount of the wax(es) being at least 2 wt. % (by dry weight), calculated from total dry weight of the barrier coating dispersion, and
at least one of the wax(es) is selected from a group consisting of polyolefin wax, paraffin wax, microcrystalline wax, bees wax, carnauba wax, rice bran wax, sugar cane wax, sunflower wax, and soy wax.
